(19) United States
(12) Patent Application Publication
(10) Pub. No.: US 2009/0187578 A1
(43) Pub. Date: Jul. 23, 2009

(54) INFORMATION PROCESSING DEVICE, INFORMATION PROCESSING METHOD AND COMPUTER PROGRAM

(75) Inventor: Toshihiro MORITA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/350,317

(22) Filed: Jan. 8, 2009

(30) Foreign Application Priority Data
Jan. 21, 2008 (JP) 2008-010959

(51) Int. Cl. G06F 17/30

(52) U.S. Cl. 707/10; 707/E17.032

(57) ABSTRACT

An information processing device is provided that performs content transfer with a content storage device on which is stored content that has content identification information, the information processing device including: a storage portion that stores content that has content identification information and records at least one of a first attribute and a second attribute that correspond to the content identification information for each of the content; a content extractor that extracts, from among the content stored in the storage portion, the content for transfer to the content storage device; and a transmission portion that transmits the content extracted by the content extractor to the content storage device in an order that is based on the first attribute and the second attribute, while giving priority to the first attribute.

### CROSS REFERENCES TO RELATED APPLICATION(S)

The present invention contains subject matter related to Japanese Patent Application JP 2008-10959 filed in the Japan Patent Office on Jan. 21, 2008, the entire contents of which being incorporated herein by reference.

### BACKGROUND OF THE INVENTION

1. Field of the Invention

The present invention relates to an information processing device, an information processing method and a computer program.

2. Description of the Related Art

Text files, image files, music files and so on that are stored in an image processing device, such as a personal computer and the like, are often arranged by a user of the information processing device in a layered structure for ease of classification. For example, the user sets up a folder to store text files, a folder to store image files, and a folder to store music files and so on. Inside the folders, more folders are created with a further layered structure, and the files are stored inside the created folders, for ease of data management.

When playing back files in which music and images (hereinafter sometimes collectively referred to as “content”) are recorded and stored using this type of layered structure, a so-called juke box program application is very often used (see, for example, Japanese Patent Application Publication No. JP-A-2006-221257). In the juke box program, a content list is displayed on the screen. The content can be displayed according to each content type (e.g. by music, or by image), and the display can be narrowed down to content belonging to a specific artist, album or genre.

Further, content transfer systems are recently becoming widespread. When an information processing device is connected to a compact mobile terminal, the content transfer system is used to transfer content between the mobile terminal and the information processing device. The content transfer system uses the juke box program to transfer the content, and the juke box program can display the content stored in the mobile terminal as well as the content stored in the information processing device. The juke box program can be used to newly transfer content to the mobile terminal, to delete content stored in the mobile terminal and the like.

Due to hardware restrictions, the mobile terminal is often unable to internally store an advanced database, making it difficult to categorize and search and display content on the mobile terminal. For that reason, when displaying a content list on the mobile terminal, in order to allow recently obtained content to be easily searched, some mobile terminals adopt a method in which the content list is organized in order of the date on which the content is obtained. A technology is disclosed, for example, in Japanese Patent Application Publication No. JP-A-2006-221257 that allows the desired download data and recorded data to be easily selected.

### SUMMARY OF THE INVENTION

However, when known mobile terminals, for example, use a juke box program to transfer content from an information processing device, problems arise with the fact that, due to the transfer order, content, such as albums, that belong to a same group are scattered when transferred. For example, when albums are transferred from the information processing device to the mobile terminal together with a playlist formed of content selected by a user, if the content contained in the transferred album is also contained in the transferred playlist, in line with the transfer of the playlist, the date and time of the content transfer cannot be grouped by album.

To address this, the present invention provides a new and improved information processing device, information processing method and computer program that, even when albums are transferred from the information processing device to the mobile terminal together with a playlist formed of content selected by the user, allow the albums to be displayed on the mobile terminal grouped by album and not displayed in a scattered manner when the content list is displayed on the mobile terminal.

According to an embodiment of the present invention, there is provided an information processing device that performs content transfer with a content storage device on which is stored content that has content identification information, the information processing device including: a storage portion that stores content that has content identification information and stores at least one of a first attribute and a second attribute that correspond to the content identification information for each of the content; a content extractor that extracts, from among the content stored in the storage portion, the content for transfer to the content storage device; and a transmission portion that transmits the content extracted by the content extractor to the content storage device in an order that is based on the first attribute and the second attribute, with priority accorded to the first attribute.

With this configuration, the storage portion stores the content with the content identification information and records at least one of the first attribute and the second attribute that correspond to the content identification information for each of the content, and the content extractor extracts the content for transfer to the content storage device from among the content stored in the storage portion. Then, the transmission portion transmits the content extracted by the content extractor to the content storage device in an order that is based on the first attribute and the second attribute, with priority given to the first attribute.

The transmission portion, when transmitting the content to the content storage device based on the first attribute, may transmit the content in descending order of the order based on the first attribute. With this configuration, when the content is transmitted from the transmission portion, the content is transmitted in descending order of the order based on the first attribute. As a result, when transmitting the content to the content storage device so that the content is displayed from the top in order of the newly transferred content, it is possible to cause the display on the content storage device to match the order of display on the information processing device of the content belonging to the first attribute.

A display portion that displays information for the content stored in the storage portion, and a control portion that controls the display of the content information on the display portion may also be provided. With this configuration, the display portion displays the information for the content stored in the storage portion, and the control portion controls the display of the content information on the display portion. Then, the control portion may display the information for the content to be transferred to the content storage device in descending order of the order based on the first attribute. Moreover, the control portion, when transmitting the content to the content storage device, may also display icons on the display portion that indicate the progress status for each of the content displayed on the display portion. As a result, it is possible to ascertain the order of transmission of the content to the content storage device and the progress status of the content transmission.

The transmission portion, depending on the type of the content storage device transferring the content, may change whether to perform transmission in descending order of the order based on the first attribute. As a result, with both a content storage device on which the content can be displayed from the top in order of the newly transferred content, and a content storage device on which this is not possible, when transmitting the content, it is possible to match the order of the display on the content storage device with the order of the display on the information processing device of the content belonging to the first attribute.

The transmission portion, when there is insufficient free space on the content storage device transferring the content, may transmit the content in an order of priority starting from the content with the most recent date and time of recording on the information processing device. As a result, the content is transmitted in order starting with the content most recently recorded on the information processing device, thus allowing playback of the most recent content on the information processing device.

The control portion, when there is insufficient free space on the content storage device transferring the content, may allow the user to select whether to transfer as much of the content as possible until the space on the content storage device becomes full. As a result, by transmitting the content in order starting with the content most recently recorded on the information processing device, the most recent content on the information processing device can be played back. Not only this, when there is insufficient free space, the user can clearly select the content to be transferred, and transfer the selected content to the content storage device.

The content extractor may perform extraction in order of the name of the first attribute and may also perform extraction in order of the date and time on which the content belonging to the first attribute is recorded to the information processing device.

According to another embodiment of the present invention, there is provided an information processing method for performing content transfer with a content storage device on which is stored information that has content identification information, the information processing method including the steps of: storing content that has content identification information and storing least one of a first attribute and a second attribute that correspond to the content identification information for each of the content; extracting, from among the content stored in the storing step, content for transfer to the content storage device; and transferring the content extracted in the content extracting step to the content storage device in an order based on the first attribute and the second attribute, with priority given to the first attribute.

With this configuration, the content that has content identification information and at least one of the first attribute and the second attribute that correspond to the content identification information for each of the content are stored in the storing step. In the content extracting step, the content to be transferred to the content storage device is extracted from among the content stored in the storing step. Then, in the transferring step, the content extracted in the content extracting step is transmitted to the content storage device in the order based on the first attribute and the second attribute, with priority given to the first attribute. As a result, the content belonging to the first attribute can be grouped together for display on the content storage device.

According to another embodiment of the present invention, there is provided a computer program that performs content transfer with a content storage device on which is stored content that has content identification information, the computer program including instructions that command a computer to perform the steps of: storing content that has content identification information and storing least one of a first attribute and a second attribute corresponding to the content identification information for each of the content; extracting, from among the content recorded in the recording step, the content for transfer to the content storage device; and transferring the content extracted in the content extracting step to the content storage device in an order based on the first attribute and the second attribute, with priority given to the first attribute.

With this configuration, the content that has content identification information and at least one of the first attribute and the second attribute that correspond to the content identification information for each of the content are stored in the storing step. In the content extracting step, the content to be transferred to the content storage device is extracted from among the content stored in the storing step. Then, in the transferring step, the content extracted in the content extracting step is transmitted to the content storage device in the order based on the first attribute and the second attribute, with priority given to the first attribute. As a result, the content belonging to the first attribute can be grouped together for display on the content storage device.

With the present invention as described above, a new and improved information processing device, information processing method and computer program can be provided that, even when albums are transferred from the information processing device to the mobile terminal together with a playlist formed of content selected by the user, allow the albums to be displayed on the mobile terminal grouped by album and not displayed in a scattered manner when the content list is displayed on the mobile terminal.

### BRIEF DESCRIPTION OF THE DRAWINGS

FIG. 1 is an explanatory diagram illustrating a content transfer system 10 according to a first embodiment of the present invention;

FIG. 2 is an explanatory diagram illustrating a structure of an information processing device 100 according to the first embodiment of the present invention;

FIG. 3 is an explanatory diagram illustrating a functional structure of the information processing device 100 according to the first embodiment of the present invention;

FIG. 4 is an explanatory diagram showing an example of a configuration of a content database 138 according to the first embodiment of the present invention;

FIG. 5 is an explanatory diagram showing an example of a configuration of a mobile device database 140 according to the first embodiment of the present invention;

FIG. 6 is an explanatory diagram illustrating a structure of a mobile terminal 200 according to the first embodiment of the present invention;

FIG. 7 is an explanatory diagram showing an example of a screen displayed on the information processing device 100;

FIG. 8 is an explanatory diagram showing an example of a screen displayed on the information processing device 100;

FIG. 9 is an explanatory diagram showing an example of a screen displayed on the information processing device 100;

FIG. 10A is a flow chart illustrating a content transfer method according to the first embodiment of the present invention;

FIG. 10B is a flow chart illustrating the content transfer method according to the first embodiment of the present invention;

FIG. 11 is a flow chart illustrating the content transfer method according to the first embodiment of the present invention;

FIG. 12 is a flow chart illustrating a case in which content transfer is performed manually;

FIG. 13 is a flow chart illustrating a content extraction method according to the first embodiment of the present invention when selecting content for automatic transfer;

FIG. 14 is a flow chart illustrating a scheduling process according to the first embodiment of the present invention to schedule the order of transfer of extracted content;

FIG. 15 is an explanatory diagram showing an example of a screen displayed on the information processing device 100 according to the first embodiment of the present invention;

FIG. 16 is an explanatory diagram showing an example of a screen displayed on the information processing device 100 according to the first embodiment of the present invention;

FIG. 17 is an explanatory diagram showing an example of a screen displayed on the information processing device 100 according to the first embodiment of the present invention;

FIG. 18 is an explanatory diagram showing an example of a screen displayed on the mobile terminal 200 according to the first embodiment of the present invention;

FIG. 19A is an explanatory diagram showing an example of a screen displayed on the mobile terminal 200 according to the first embodiment of the present invention;

FIG. 19B is an explanatory diagram showing an example of a screen displayed on the mobile terminal 200 according to the first embodiment of the present invention;

FIG. 20 is a flow chart illustrating a modified example of the scheduling process according to the first embodiment of the present invention to schedule the order of transfer of extracted content; and

FIG. 21 is a flow chart illustrating a modified example of the content transfer method according to the first embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

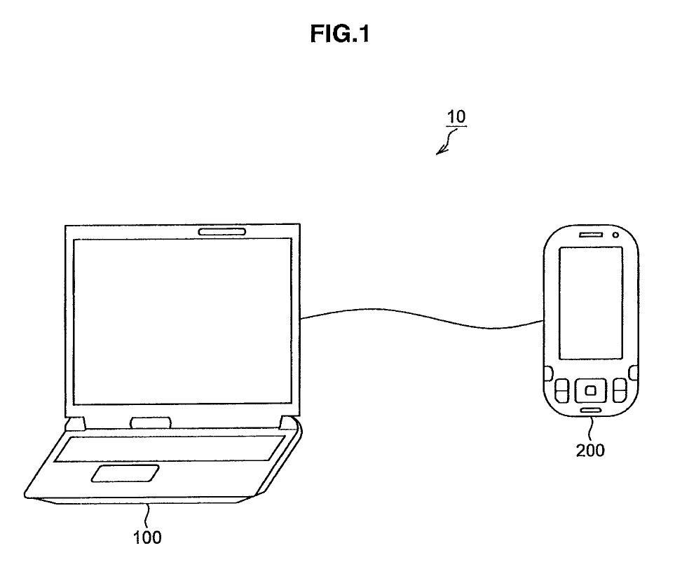

First, a content transfer system according to a first embodiment of the present invention will be explained. FIG. 1 is an explanatory diagram illustrating a structure of a content transfer system 10 according to the first embodiment of the present invention. Hereinafter, the content transfer system 10 according to the first embodiment of the present invention will be explained with reference to FIG. 1.

As shown in FIG. 1, the content transfer system 10 according to the first embodiment of the present invention includes an information processing device 100 and a mobile terminal 200. The content transfer system 10 shown in FIG. 1 is a system that transfers content between the information processing device 100 and the mobile terminal 200. For example, the content transfer system 10 can transfer a piece of music read into the information processing device 100 from a compact disc (CD) to the mobile terminal 200 and can back up a piece of music downloaded into the mobile terminal 200 from a server of a music provider or the like via a communications network onto the information processing device 100. The information processing device 100 and the mobile terminal 200 can be connected using a universal serial bus (USB) cable, an IEEE1394 compliant cable or the like.

The information processing device 100 is a device that internally stores and uses a variety of information, such as a personal computer (PC) for example. In the present embodiment, the information processing device 100 performs content transfer between the information processing device 100 and the mobile terminal 200, and manages content recorded from the information processing device 100 to the mobile terminal 200 (e.g the editing and deleting of the content and so on). An internal structure of the information processing device 100 will be explained in more detail later.

The mobile terminal 200 is a compact terminal for portable use, such as a mobile telephone, a mobile game console, or a mobile music playback device, for example. In the first embodiment, the mobile terminal 200 is explained using an example of a mobile telephone. An internal structure of the mobile terminal 200 will be explained in more detail later.

The content transfer system 10 according to the first embodiment of the present invention is explained above. Next, the structure of the information processing device 100 according to the first embodiment of the present invention will be explained.

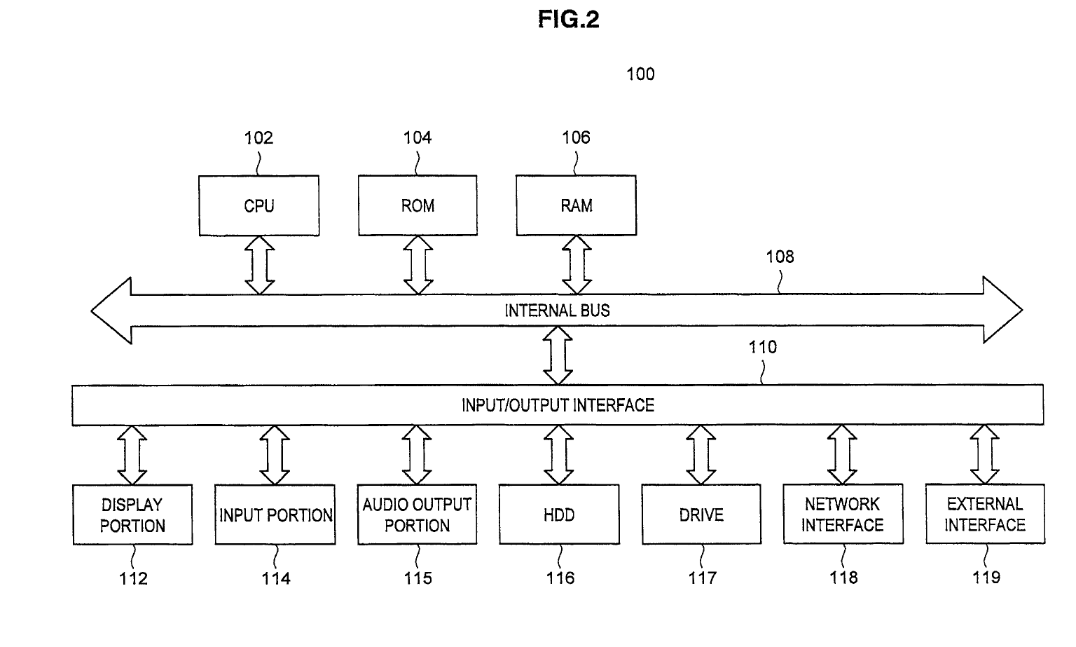

FIG. 2 is an explanatory diagram illustrating the structure of the information processing device 100 according to the first embodiment of the present invention. Below, the structure of the information processing device 100 according to the first embodiment of the present invention will be explained with reference to FIG. 2.

As shown in FIG. 2, the information processing device 100 according to the first embodiment of the present invention includes a central processing unit (CPU) 102, a read only memory (ROM) 104, a random access memory (RAM) 106, an internal bus 108, an input/output interface 110, a display portion 112, an input portion 114, an audio output portion 115, a hard disk drive (HDD) 116, a drive 117, a network interface 118 and an external interface 119.

The CPU 102 performs numerical calculations and information processing, and instrument control etc. It performs the numerical calculations, information processing and instrument control by sequentially reading programs stored in the ROM 104 and data stored in the RAM 106, or, for example, based on a signal in response to an instruction input by a user of the information processing device 100 via the input portion 114 or based on a signal transmitted from an external instrument via the network interface 118.

In principle, of the programs and calculation parameters used in the numerical calculation, information processing and instrument control and so on by the CPU 102, the ROM 104 stores fixed data that is not changed. Meanwhile, in principle, of the programs and calculation parameters used in the numerical calculation, information processing and instrument control and so on by the CPU 102, the RAM 106 stores data that changes in accordance with various types of processing.

The internal bus 108 is a path that is used when data is internally exchanged within the information processing device 100. The CPU 102, the ROM 104 and the RAM 106 are all mutually connected by the internal bus 108. The internal bus 108 is also connected to the input/output interface 110, and transfers to the CPU 102 signals in response to instructions transmitted via the input/output interface 110 from the input portion 114 or signals transmitted via the network interface 118 from another device connected to the information processing device 100 by a network.

The input/output interface 110 mediates input and output transfer of information. The input/output interface 110 is connected to the display portion 112, the input portion 114, the audio output portion 115, the drive 117, the network interface 118 and the external interface 119. The input/output interface 110 is further connected to the internal bus 108, as described above, and transfers to the CPU 102 via the internal bus 108 signals in response to instructions input from the input portion 114 or signals transmitted via the network interface 118 from another device connected to the information processing device 100 by a network.

The display portion 112 displays content input from the input portion 114, and information relating to the results of the numerical calculations and information processing, and instrument control and the like performed by the CPU 102. The display portion 112 is, for example, formed of a liquid crystal display device, an organic EL display device or the like.

The input portion 114 is operated, for example, when the user of the information processing device 100 inputs any type of instruction to the CPU 102. The input portion 114 is, for example, formed of a button, a keyboard, a touch pad or the like.

When a process involving audio output is performed in relation to the information processing device 100, the audio output portion 115 outputs the audio generated by the process. The HDD 116 is provided with an internal hard disk, drives the hard disk, and records and plays back programs and information (e.g. audio files and video files) that are read and executed by the CPU 102. The drive 117 is provided with a portable recording medium and performs data transfer between the recording medium and the information processing device 100. The portable recording medium may be, for example, a magnetic disk, an optical disk, a magneto-optical disk, a semiconductor memory or the like, and the drive 117 can use a device that is able to read such types of recording medium.

The network interface 118 performs the transfer of information between the information processing device 100 and another device, for example, the mobile terminal 200, that is connected to the information processing device 100 via a wired or a wireless network connection. The external interface 119 mediates the transfer of information between the information processing device 100 and a peripheral device, for example, the mobile terminal 200, that is used when connected to the information processing device 100. The external interface 119 is, for example, formed of a universal serial bus (USB) port or the like.

The structure of the information processing device 100 according to the first embodiment of the present invention is described above. Next, a functional structure of the information processing device 100 according to the first embodiment of the present invention will be explained.

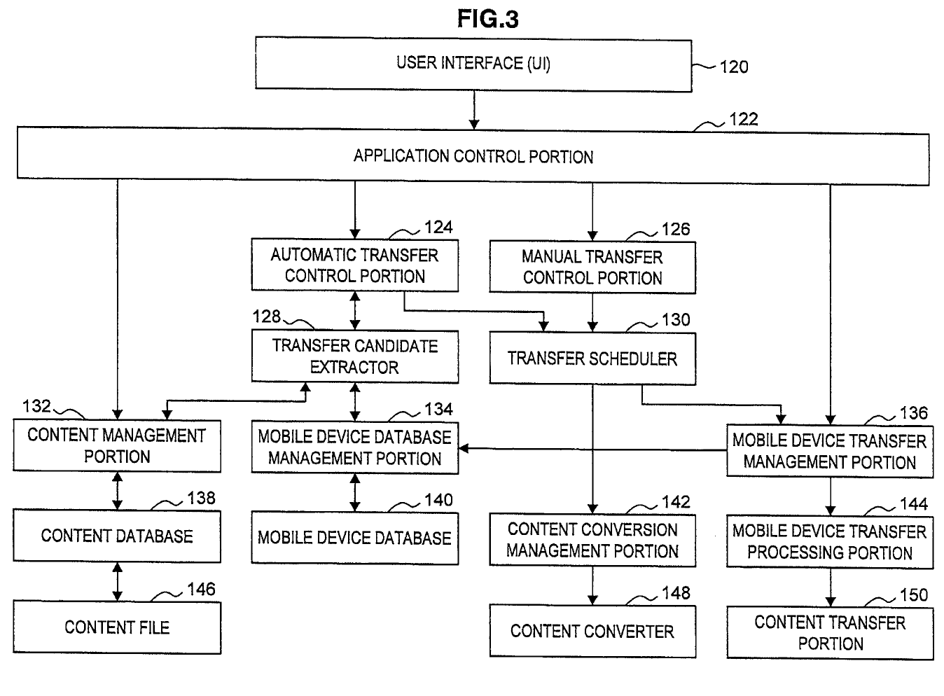

FIG. 3 is an explanatory diagram illustrating the functional structure of the information processing device 100 according to the first embodiment of the present invention. Hereinafter, the functional structure of the information processing device 100 according to the first embodiment of the present invention will be explained with reference to FIG. 3.

As shown in FIG. 3, the information processing device 100 according to the first embodiment of the present invention includes a user interface (UI) 120, an application control portion 122, an automatic transfer control portion 124, a manual transfer control portion 126, a transfer candidate extractor 128, a transfer scheduler 130, a content management portion 132, a mobile device database management portion 134, a mobile device transfer management portion 136, a content database 138, a mobile device database 140, a content conversion management portion 142, a mobile device transfer processor 144, a content file 146, a content converter 148 and a content transfer portion 150.

The user interface (UI) 120 displays a list of albums, music, videos and playlists stored in the information processing device 100 and a list of the albums, music, videos and playlists stored in the mobile terminal 200 on the display portion 112, using a juke box program. A user can make a selection from the list displayed on the display portion 112 by the user interface 120 in accordance with instructions from the user and play back music, perform transfer to the mobile terminal 200 and the like. Note that the display content of the juke box program displayed on the display portion 112 by the user interface 120 will be explained later.

The application control portion 122 receives a user operation that is performed on the screen displayed on the display portion 112 by the user interface 120, and controls the overall operation of the juke box program.

When content is automatically transferred between the information processing device 100 and the mobile terminal 200, the automatic transfer control portion 124 controls the content transfer. When the content is automatically transferred between the information processing device 100 and the mobile terminal 200, the automatic transfer control portion 124 performs control by receiving transfer candidates extracted by the transfer candidate extractor 128 (to be described later) and transmitting content information relating to the received transfer candidates to the transfer scheduler 130.

When content is manually transferred between the information processing device 100 and the mobile terminal 200, the manual transfer control portion 126 controls the content transfer. To manually transfer the content between the information processing device 100 and the mobile terminal 200, the user selects for transfer content or a playlist that contains a plurality of the content on the juke box program, and then information relating to the selected content or playlist is transmitted to the transfer scheduler 130.

When the content is automatically transferred between the information processing device 100 and the mobile terminal 200, the transfer candidate extractor 128 extracts content candidates for transfer from the information processing device 100 to the mobile terminal 200. The extraction of transfer content candidates is performed by comparing the content of data stored in the content database 138 (to be described later) with that stored in the mobile device database 140 (to be described later).

The transfer scheduler 130 receives transfer candidate content and playlist information from the automatic transfer control portion 124 and the manual transfer control portion 126, and, based on the received information, sequentially transmits the content one at a time to the mobile device transfer management portion 136.

The content management portion 132 manages content played back on the juke box program and playlists created on the juke box program. When the content management portion 132 receives instructions from the transfer candidate extractor 128 to extract content transfer candidates, the content management portion 132 acquires content and playlist information from the content database 138 and transmits the acquired information to the transfer candidate extractor 128.

The mobile device database management portion 134 manages a cache of a content list stored on a mobile device (for example, the mobile terminal 200). The cache of the content list stored on the mobile device is stored in the mobile device database 140. When the content is transferred automatically between the information processing device 100 and the mobile terminal 200, the content list stored in advance on the mobile terminal 200 is held as a cache in the mobile device database 140, and by acquiring the information from the mobile device database 140, the extraction of the transfer candidates can be performed at high speed. With regard to a timing to acquire the content list stored in the mobile terminal 200 in order to form a cache in the mobile device database 140, the content list may be acquired, for example, at the point in time at which the information processing device 100 is connected to the mobile terminal 200 and the juke box program is activated on the information processing device 100.

The mobile device transfer management portion 136 coordinates output processing to the mobile device and input processing from the mobile device. When the mobile device is connected to the information processing device 100, the mobile device transfer management portion 136 reads a song list contained in the connected mobile device, and transmits the read content to the mobile device database management portion 134. When the mobile device database management portion 134 receives the transmitted content, by storing the content read out by the mobile device transfer management portion 136 onto the mobile device database 140, a cache is created of the song list stored on the mobile device. Further, when the mobile device transfer management portion 136 receives an instruction from the transfer scheduler 130 to transfer content to the mobile device, it transfers the specified music or playlist to the mobile device.

The content database 138 is a database to store data related to the content. The data related to the content includes identification information that is mapped to the recorded content and identifies the recorded content, such as, for example, the content type, the content title name, and, when the content is music, the album name, the artist name and the composer name included in the content. Also included, for example, is the content storage location, a playlist name and so on. The data recorded in the content database 138 is mapped to the content file 146. The content file 146 specifies a generic name of a file in which music and video content etc. are recorded and is, for example, stored in the HDD116.

The mobile device database 140 stores and manages the content of the mobile device song list. When the communication speed with the mobile device is slow, it sometimes takes time to transfer the content and the information with the mobile device. For that reason, in order for the song list information included in the connected mobile device to be acquired and stored as a cache in the information processing device 100 at the point in time at which the information processing device 100 is connected to the mobile device, the song list information is stored in the mobile device database 140.

In order to convert the content stored in the information processing device 100 to a format that can be played back on the mobile device, the content conversion management portion 142 controls the content converter 148. Based on controls from the content conversion management portion 142, the content converter 148 converts the content stored in the information processing device 100 to a format that can be played back on the mobile device. Note that the content converter 148 may be stored in the information processing device 100 using, for example, a so-called plug-in format.

The mobile device transfer processor 144 processes the transfer of the content to the mobile device. The content to be transferred to the mobile device is determined by the automatic transfer control portion 124 or the manual transfer control portion 126. Based on instructions from the mobile device transfer processor 144, the content transfer portion 150 performs the transfer of the content to the mobile device. Note that the content transfer portion 150 may be stored in the information processing device 100 using, for example, a so-called plug-in format. When it is stored using a plug-in format, the content transfer portion 150 may be provided with respective plug-ins for each type of mobile device.

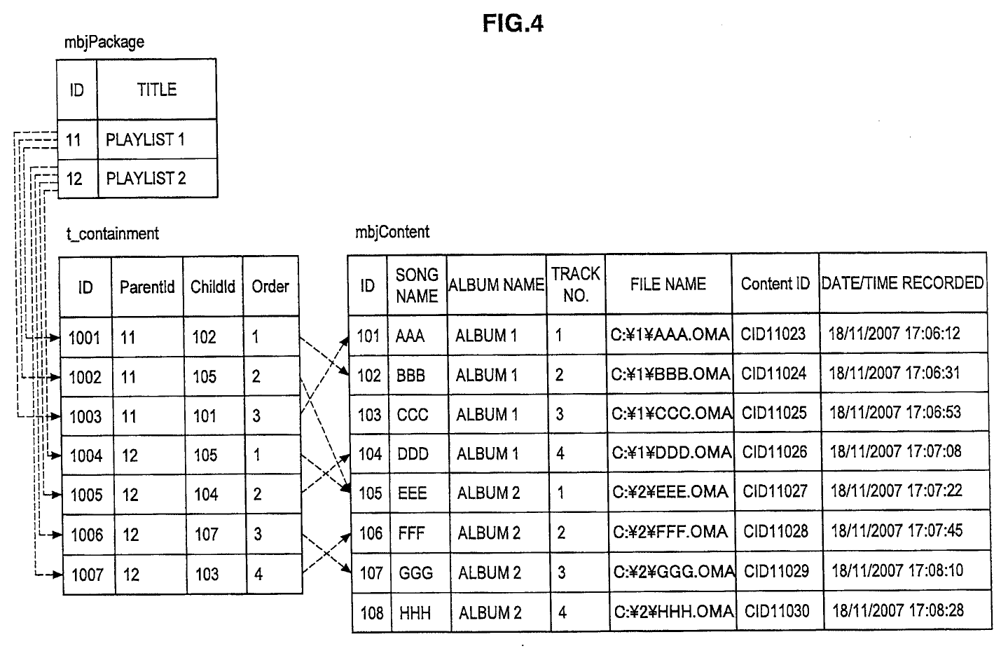

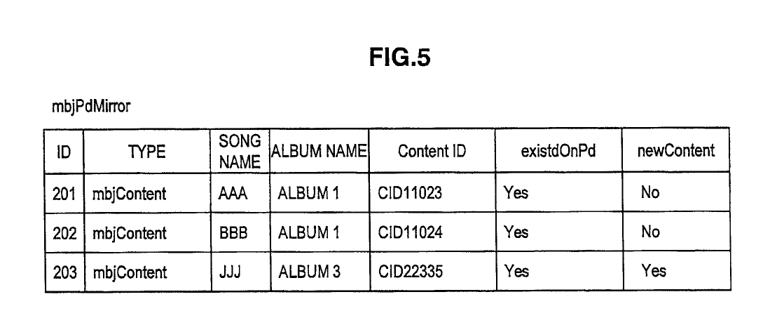

FIG. 4 is an explanatory diagram showing an example of a configuration of the content database 138 according to the first embodiment of the present invention. FIG. 5 is an explanatory diagram showing an example of a configuration of the mobile device database 140 according to the first embodiment of the present invention.

With the configuration of the content database 138 shown in FIG. 4, the “mbjPackage” table is a table storing playlist information, the “t_containment” table is a table linking the playlists and music, and the “mbjContent” table is a table storing information for the music.

The “mbjPackage” table includes an ID column and a title column. The ID column stores uniquely designated data used to manage the playlist, and the title column stores the name of the playlist, which can be freely set by the user.

The “mbjContent” table includes an ID column, a song name column, an album name column, a track number column, a file name column and a content ID column. The ID column stores uniquely designated data used to manage the content, the song name column stores the name of the song for the music, the album name column stores the name of the album that includes the music, and the track number column stores the track number with respect to the album. The track number is a number starting with the number one (1), and the numbers are sequentially allocated for each album. Further, in the file name column is stored information including a full path description of the location in which the music file (the content file 146) is saved. The content ID column stores ID that is uniquely assigned to the music.

Moreover, the “mbjContent” table may be provided with a date/time recorded column, in which is stored the date and time at which the content is recorded in (saved to) the information processing device 100.

The role of the “t_containment” table is to be an intermediate table that links the data stored in the “mbjPackage” table and data stored in the “mbjContent” table. The “t_containment” table includes an ID column, a parentId column, a childId column and an order column. The ID column stores uniquely designated data, the parentId column stores data mapped to the “mbjPackage” table ID column, and the childId column stores data mapped to the “mbjContent” table ID column. Further, the order column stores information about the song order for the music on a playlist. The song order is a number starting with the number one (1), and the numbers are sequentially allocated for each playlist.

Meanwhile, with the configuration of the mobile device database 140 shown in FIG. 5, an “mbjPdMirror” table is a table that stores information for content stored in the mobile device. The “mbjPdMirror” table includes an ID column, a type column, a song name column, an album name column, a content ID column, an existdOnPd column and a newContent column.

The ID column stores uniquely designated data used to manage the content stored on the mobile device, and the type column stores information to identify which of the content is in the row. In the first embodiment, if the row is music, data named “mbjContent” is stored, and if the row is a playlist, data named “mbjPackage” is stored. The song name column stores the name of the song for the music, and the album name column stores the name of the album that includes the music. The content ID column stores ID uniquely assigned to the content.

Further, the existdOnPd column stores information that indicates whether or not the relevant content actually exists in the mobile device, while the newContent column stores information that indicates whether or not the relevant content has been newly generated on the mobile device.

Of course, the content database 138 and the mobile device database 140 may include a table or tables other than those shown in FIG. 4 and FIG. 5. It also goes without saying that the table configuration of the content database 138 is not limited to the example shown in FIG. 4, as long as it is a configuration in which playlists and music are mapped.

The functional structure of the information processing device 100 according to the first embodiment of the present invention is explained above. Next, a structure of the mobile terminal 200 according to the first embodiment of the present invention will be explained.

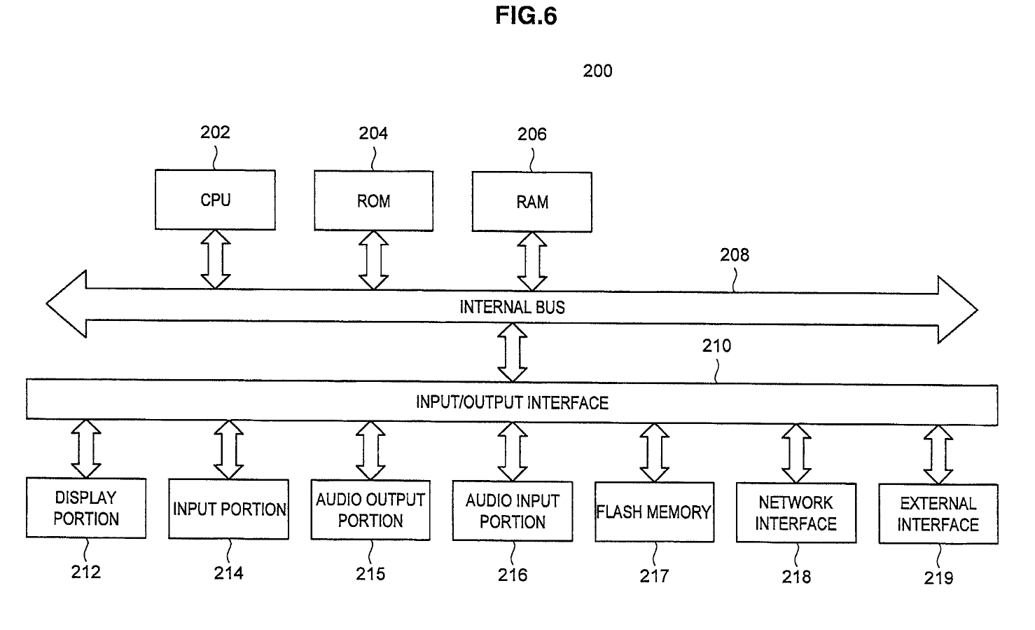

FIG. 6 is an explanatory diagram illustrating the structure of the mobile terminal 200 according to the first embodiment of the present invention. Hereinafter, the structure of the mobile terminal 200 according to the first embodiment of the present invention will be explained with reference to FIG. 6.

As shown in FIG. 6, the mobile terminal 200 according to the first embodiment of the present invention includes a CPU 202, a ROM 204, a RAM 206, an internal bus 208, an input/output interface 210, a display portion 212, an input portion 214, an audio output portion 215, an audio input portion 216, a flash memory 217, a network interface 218 and an external interface 219.

Here, the CPU 202, the ROM 204, the RAM 206, the internal bus 208, the input/output interface 210, the display portion 212, the input portion 214, the audio output portion 215, the audio input portion 216, the network interface 218 and the external interface 219 have the same functions as the CPU 102, the ROM 104, the RAM 106, the internal bus 108, the input/output interface 110, the display portion 112, the input portion 114, the audio output portion 115, the network interface 118 and the external interface 119 of the information processing device 100 shown in FIG. 2, and a detailed explanation is therefore omitted here. Note that, given the fact that the structural members of the mobile terminal 200 are used in a portable manner, the structural members of the mobile terminal 200 may have some limitations in terms of function in comparison to the structural members of the information processing device 100.

The flash memory 217 is a rewritable memory, and is, in contrast to the RAM 206, a non-volatile memory on which data is not lost when the power source is switched off. The flash memory 217 is therefore suitable for the storage of telephone directory data, emails received on the mobile terminal 200, and content downloaded via a communications network or transferred from the information processing device 100.

Note that, although not shown in FIG. 6, the mobile terminal 200 may be provided with a slot that allows the insertion of a compact recording medium, such as a memory stick (registered trademark). By inserting a compact recording medium in the slot, content can also be stored in addition to storage on the flash memory 217.

The structure of the mobile terminal 200 according to the first embodiment of the present invention is explained above with reference to FIG. 6. Next, screens displayed on the information processing device 100 for use in the content transfer system 10 according to the first embodiment of the present invention will be explained.

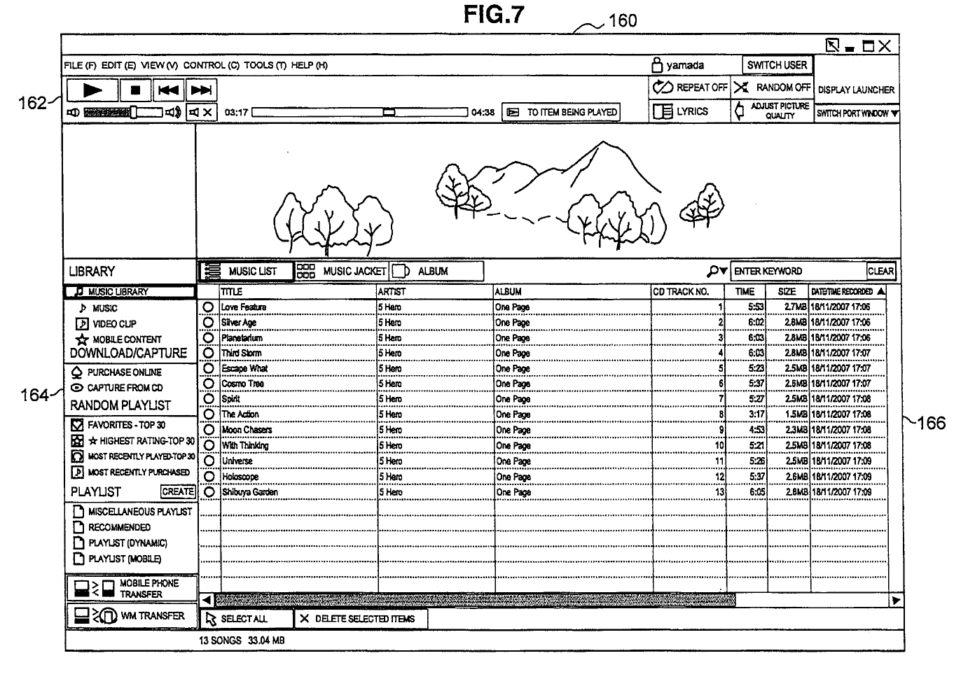

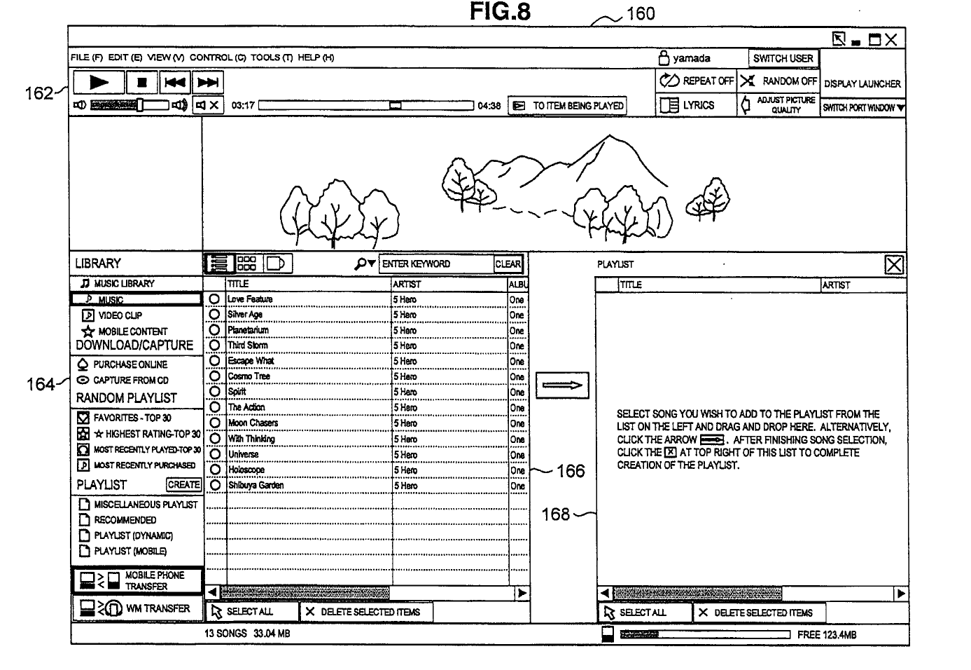

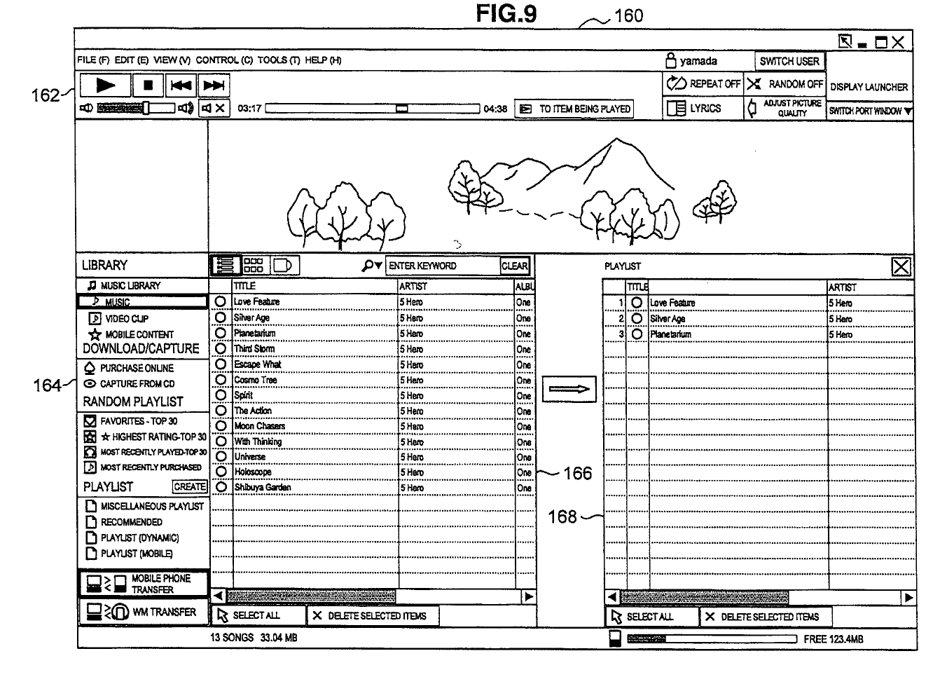

FIG. 7, FIG. 8 and FIG. 9 are explanatory diagrams showing respective examples of screens displayed on the display portion 112 of the information processing device 100 for use in the content transfer system 10 according to the first embodiment of the present invention. Hereinafter, the screens displayed on the information processing device 100 for use in the content transfer system 10 according to the first embodiment of the present invention will be explained with reference to FIG. 7, FIG. 8 and FIG. 9.

FIG. 7 shows the screen that is displayed on the display portion 112 in a case when a juke box program 160 according to the first embodiment of the present invention is executed on the information processing device 100. The main juke box program 160 is stored, for example, on the HDD 116, and is executed by loading relevant programs onto the RAM 106 and sequentially executing the programs loaded onto the RAM 106 by the CPU 102. The juke box program 160 according to the first embodiment of the present invention displays information on the display portion 112, including a content operation portion 162, a side bar 164 and a PC content display portion 166.

In relation to the content displayed on the PC content display portion 166, the content operation portion 162 instructs content playback, pause, stop, volume adjustment during content playback, adjustment of playback position, skipping of content, repeat playback, shuffle playback and so on. The jacket of the content being played back, or images related to the content being played back and so on may also be displayed on the content operation portion 162.

The side bar 164 switches the content displayed on the PC content display portion 166, performs content transfer between the information processing device 100 and the mobile terminal 200 and the like. For example, by clicking a mouse or the like to select “Music Library” under the “Library” heading on the side bar 164, a list of content is displayed on the PC content display portion 166 relating to the music that can be played back on the information processing device 100. By selecting “Music” under the “Music Library” heading, from among the content relating to music, music files are extracted and displayed on the PC content display portion 166 that are encrypted by a compression method, such as MPEG audio layer-3 (MP3), advanced audio coding (AAC), adaptive transform acoustic coding (ATRAC) and the like. Of course, selection can also be made from the side bar 164 so that all of the content list is displayed regardless of type.

The PC content display portion 166 displays the list of content that can be played back on the information processing device 100. The display of the content list on the PC content display portion 166 is changed by operation of the side bar 164. On the PC content display portion 166, the content is displayed in a list format according to content attribute information. The content attribute information may include, for example, the content title, the content playback time, the content artist name, the name of the album containing the content, an evaluation of the content by the user, the content size, the date and time of recording of the content on the information processing device 100, the content genre and so on. The content attribute information is stored internally in the information processing device 100, for example in the HDD 116, in metadata format.

FIG. 8 and FIG. 9 show examples of screens displayed in cases when the juke box program 160 is used to create a playlist. In FIG. 8 and FIG. 9, in comparison to FIG. 7, the width of the PC content display portion 166 is narrower, and a playlist display portion 168 is newly displayed. When music that is to be added to the playlist is selected from the list of music displayed on the PC content display portion 166, the selected music is displayed in the playlist display portion 168, as shown in FIG. 9. Then, by saving the created playlist, music can of course be played back on the information processing device 100 in accordance with the playlist, and the playlist can also be transferred to the mobile device, such as the mobile terminal 200 etc. along with the music data, thus allowing music to also be played back on the mobile device in accordance with the playlist created by the user on the information processing device 100.

The screens displayed on the information processing device 100 used in the content transfer system 10 according to the first embodiment of the present invention are explained above. Next, a content transfer method according to the first embodiment of the present invention will be explained.

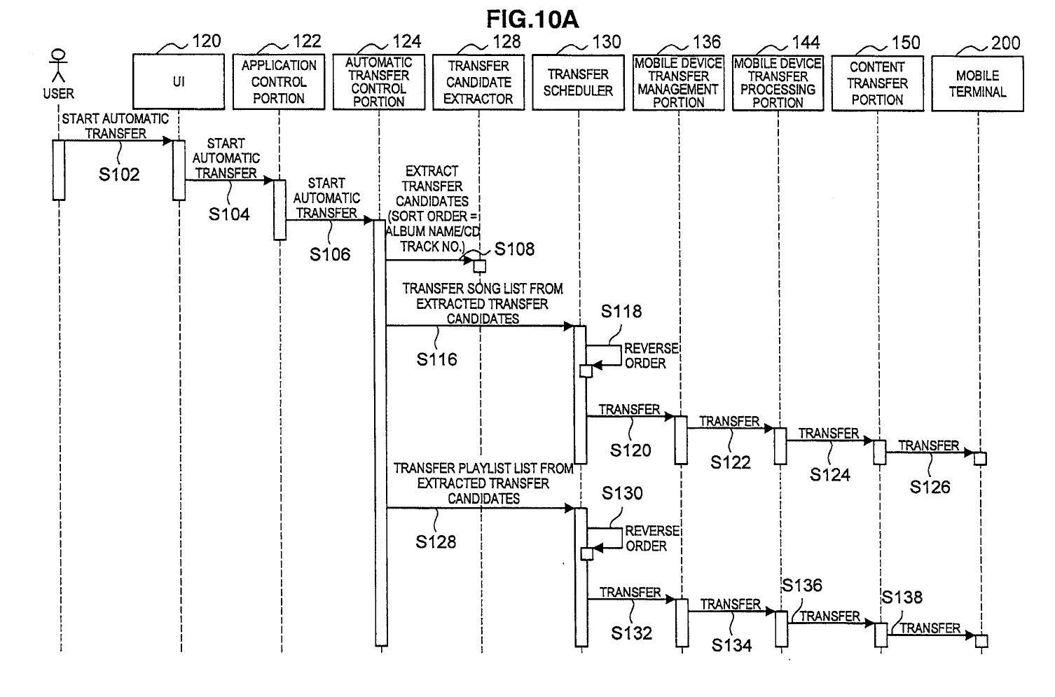

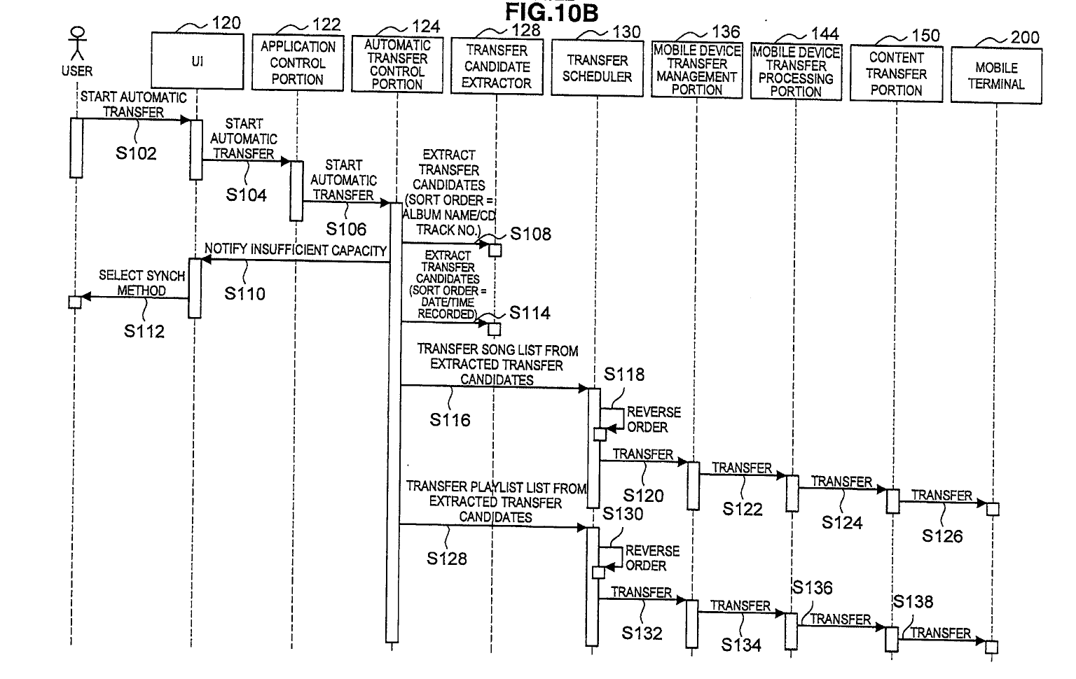

FIG. 10A and FIG. 10B are flow charts illustrating the content transfer method according to the first embodiment of the present invention. Hereinafter, the content transfer method according to the first embodiment of the present invention will be explained with reference to FIG. 10A and FIG. 10B. FIG. 10A and FIG. 10B both show cases in which the content is automatically transferred from the information processing device 100 to the mobile terminal 200. In the example described here, the content is a music file that is transferred from the information processing device 100 to the mobile terminal 200. Note that when the content is transferred automatically from the information processing device 100 to the mobile terminal 200, music information stored in advance in the mobile terminal 200 is music information held as a cache in the information processing device 100.

To start with, the content transfer method according to the first embodiment of the present invention will be explained with reference to FIG. 10A. First, the user instructs the user interface 120 to start automatic transfer of the music (step S102). In the first embodiment, the instruction to start automatic transfer may be performed, for example, by using a mouse to click on a transfer button (to be described later) displayed on the juke box program 160.

When the user instructs the user interface 120 to start the automatic transfer of the music, the user interface 120 instructs the application control portion 122 to start the automatic transfer of the music (step S104). Further, when the application control portion 122 receives the instruction, it instructs the automatic transfer control portion 124 to start the automatic transfer of the music (step S106).

When the automatic transfer control portion 124 receives the instruction from the application control portion 122 to start the automatic transfer of the content, it instructs the transfer candidate extractor 128 to extract music candidates for transfer to the mobile terminal 200. When the transfer candidate extractor 128 receives the instruction, it extracts transfer music candidates based on the instruction (step S108). Here, the music targeted for extraction is the music that is not stored on the mobile terminal 200, and when it is extracted, the sort order is in ascending order of the album name and the CD track number. Further, the music extracted at this time is not only the music that is contained in albums, but also includes the music stored in playlists created by the user. Note that a method for extracting transfer music candidates by the transfer candidate extractor 128 will be explained in more detail later.

When the transfer music candidates are extracted by the transfer candidate extractor 128, the transfer scheduler 130 is instructed to first transfer a song list from among the extracted music. In other words, it is instructed to transfer the music in units of album, which is the example of a first attribute in the present invention (step S116). When the transfer scheduler 130 receives the instruction to transfer the song list, it reverses the order of the music that is transferred as the song list from among the music extracted by the transfer candidate extractor 128, reversing the music order in units of album (step S118). In other words, the transfer scheduler 130 reverses the order of the song list that is sorted in ascending order of the CD track number, and re-sorts the list in descending order of the CD track number.

When the order of the music is re-sorted in step S118, the mobile device transfer management portion 136 is instructed to transfer the music to the mobile terminal 200 in the re-sorted order (step S120). When the mobile device transfer management portion 136 receives the instruction, it instructs the mobile device transfer processor 144 to transfer the music to the mobile terminal 200 in the re-sorted order (step S122). When the mobile device transfer processor 144 receives the instruction, it then instructs the content transfer portion 150 to transfer the music to the mobile terminal 200 in the re-sorted order (step S124). When the content transfer portion 150 receives the instruction, it transfers the music one song at a time to the mobile terminal 200 in the specified order (step S126).

When the song list transfer is complete, the transfer candidate extractor 128 next transfers the list of playlists. In other words, the transfer candidate extractor 128 instructs the transfer scheduler 130 to transfer the music belonging to the playlists created by the user, the playlists being an example of a second attribute in the present invention (step S128). When the transfer scheduler 130 receives the instruction to transfer the playlist list, it reverses the sort order of the music that is transferred as a playlist list, reversing the order in units of playlist (step S130). In other words, the transfer scheduler 130 reverses the order, in units of playlist, of the playlists that are sorted in ascending order of the Order column on the “t_containment” table to a sort order that is in descending order of the Order column.

When the music is re-sorted in step S130, the mobile device transfer management portion 136 is instructed to transfer the music to the mobile terminal 200 in the re-sorted order (step S132). When the mobile device transfer management portion 136 receives the instruction, it instructs the mobile device transfer processor 144 to transfer the music to the mobile terminal 200 in the re-sorted order (step S134). Then, when the mobile device transfer processor 144 receives the instruction, it instructs the content transfer portion 150 to transfer the music to the mobile terminal 200 in the re-sorted order (step S136). When the content transfer portion 150 receives the instruction, it transfers the music to the mobile terminal 200 one song at a time in the specified order (step S138).

The content transfer method according to the first embodiment of the present invention is explained above with reference to FIG. 10A. Note that when the content is transferred from the information processing device 100 to the mobile terminal 200, even when the transfer candidate content is extracted from the information processing device 100, if there is insufficient free space on the mobile terminal 200, sometimes all the extracted content cannot be transferred. FIG. 10B is a flow chart illustrating the content transfer method according to the first embodiment of the present invention taking the above situation into account.

FIG. 10B is identical to FIG. 10A from step S102, in which the user instructs the start of the automatic transfer, through to step S108, in which the automatic transfer control portion 124 extracts the transfer candidate music. Here, if the total volume of extracted music is more than the free space remaining in the mobile terminal 200, the automatic transfer control portion 124 notifies the user interface 120 that there is insufficient free space (step S110), and the user interface 120 displays a screen to the user on which to select a transfer method (a sync method) (step S112). For the transfer method, the user can select whether to automatically transfer as much of the music as possible as allowed by the free space on the mobile terminal 200, or to manually select the music for transfer and transfer the music (in other words, cancel the automatic transfer).

In step S112, if the user selects to automatically transfer as much of the music as possible as allowed by the free space on the mobile terminal 200, the automatic transfer control portion 124 once more extracts the transfer candidate music (step S114). When extracting the music in step S114, the music targeted for extraction is the music that is not stored on the mobile terminal 200, and the music is selected for extraction in order from the most recent date and time on which the music was stored on the information processing device 100.

After the extraction of the transfer candidate music is completed in step S114, from the transfer of the song list by the transfer scheduler 130 in step S116 onwards, the process is the same as for FIG. 10A and a detailed explanation is therefore omitted here.

Note that, in FIG. 10A and FIG. 10B, when the transfer of the music by the content transfer portion 150 to the mobile terminal 200 in step S126 and step S138 is complete, the content transfer portion 150 may notify the transfer scheduler 130 in return that the music transfer is complete.

The content transfer according to the first embodiment of the present invention is explained above with reference to FIG. 10A and FIG. 10B. Next, each individual process of the content transfer method according to the first embodiment of the present invention will be explained in detail.

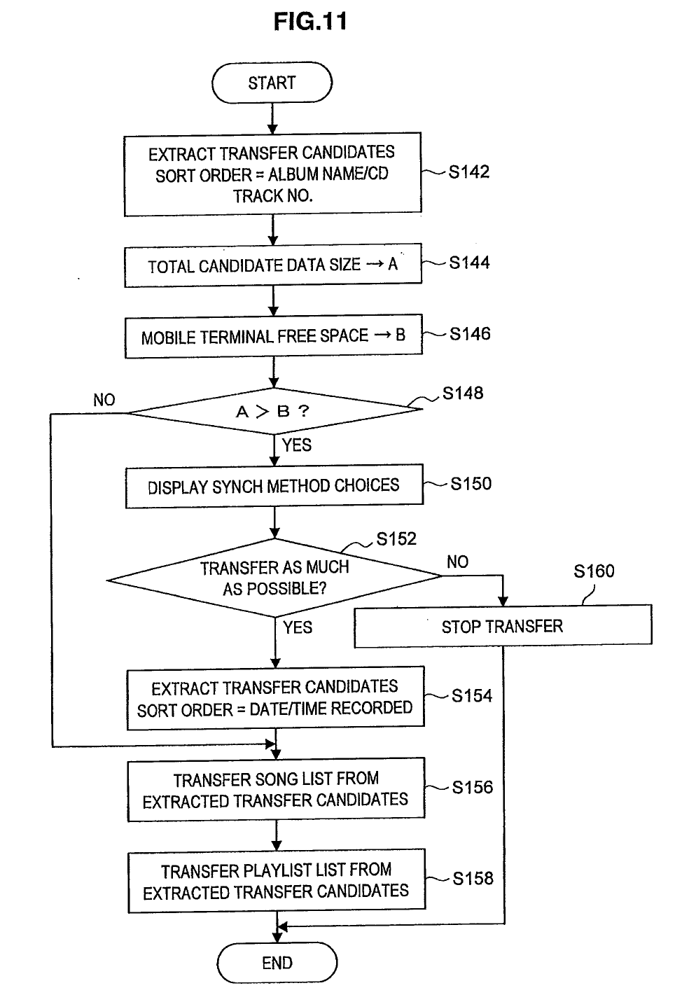

FIG. 11 is a flow chart illustrating the content transfer method according to the first embodiment of the present invention. Hereinafter, the content transfer method according to the first embodiment of the present invention will be explained with reference to FIG. 11.

As described above, when the music for transfer from the information processing device 100 to the mobile terminal 200 is automatically extracted and the extracted music transferred from the information processing device 100 to the mobile terminal 200, first the candidate music for transfer is extracted by the automatic transfer control portion 124 (step S142). When extracting the transfer candidates, the music is sorted in ascending order by the name of the album and by the CD track number.

When the candidate music for transfer is extracted by the automatic transfer control portion 124 in step S142, the total data size of the music extracted by the automatic transfer control portion 124 is calculated (step S144), and next, the free space on the mobile terminal 200 is calculated (step S146). The calculation of the total data size of the music and the calculation of the free space on the mobile terminal 200 may be performed in reverse.

When the calculation of the total data size of the extracted music and the calculation of the free space on the mobile terminal 200 are complete, it is determined whether or not the free space remaining on the mobile terminal 200 is less than the total data size of the extracted music (step S148). If the free space on the mobile terminal 200 is less than the total data size of the extracted music, the automatic transfer control portion 124 notifies the user interface 120 that there is insufficient free space on the mobile terminal 200 and instructs the user interface 120 to display sync method choices (step S150).

Next, the user interface 120 determines whether or not the user has selected to automatically transfer as much of the music as possible as allowed by the free space on the mobile terminal 200 (step S152). If the user has selected to transfer as much of the music as possible, the automatic transfer control portion 124 once more extracts candidate music for transfer (step S154). In step S154, the music is extracted in order from the most recent date and time of recording on the information processing device 100 and is extracted until it fills the free space on the mobile terminal 200.

When it is determined in the above-described step S148 that the free space on the mobile terminal 200 is greater than the total data size of the extracted music, or when the extraction of the candidate music for transfer is complete in the above-described step S154, first the song list is transferred from among the extracted transfer candidates (step S156). The transfer of the song list is the transfer of the extracted music in units of album. When the song list is transferred, next, the playlist list is transferred from among the extracted transfer candidates (step S158). The transfer of the playlist list is the transfer of playlists created by the user and of music that is included in the playlists and included in the extracted transfer candidates.

Note that, in the above-described step S152, if the user does not select to transfer as much of the music as possible, the automatic transfer process to the mobile terminal 200 is cancelled (step S160).

The content transfer method according to the first embodiment of the present invention is explained above with reference to FIG. 11. Next, the performing of manual content transfer in the content transfer method according to the first embodiment of the present invention will be explained.

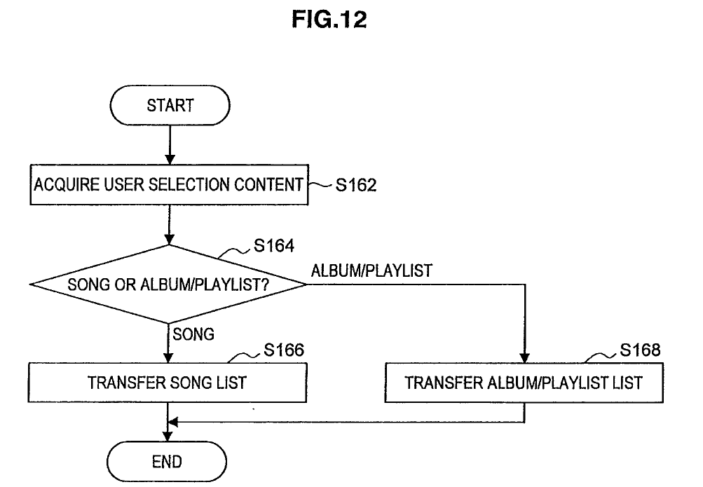

FIG. 12 is a flow chart illustrating a case in which manual content transfer is performed in the content transfer method according to the first embodiment of the present invention. As shown in FIG. 12, when performing the manual content transfer, first, the user interface 120 acquires the selection made by the user (step S162). The user selection acquired by the user interface 120 is transmitted to the manual transfer control portion 126 via the application control portion 122. The manual transfer control portion 126 determines whether the user selection specifies transfer in units of music or transfer in units of album or playlist (step S164).

As a result of the determination made in step S164, if the user has selected to perform the transfer in units of music, the manual transfer control portion 126 controls the transfer scheduler 130 so that the transfer is performed in units of music (step S166). On the other hand, as a result of the determination made in step S164, if the user has selected to perform the transfer in units of album or playlist, the manual transfer control portion 126 controls the transfer scheduler 130 so that the transfer is performed in units of album or playlist (step S168).

In this way, the method of content transfer by the information processing device 100 is controlled based on the user selection, and the content transfer from the information processing device 100 to the mobile terminal 200 can be performed manually.

The manual content transfer in the content transfer method according to the first embodiment of the present invention is explained above with reference to FIG. 12. Next, a content extraction method will be explained when automatic content transfer is selected in the content transfer method according to the first embodiment of the present invention.

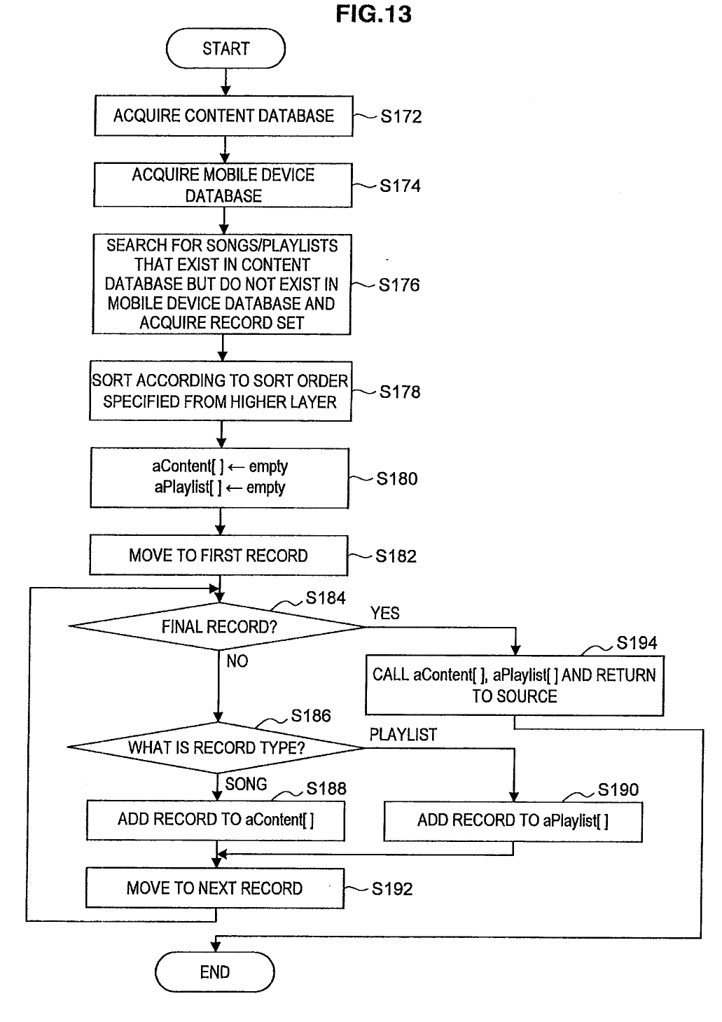

FIG. 13 is a flow chart illustrating the content extraction method when automatic content transfer is selected in the content transfer method according to the first embodiment of the present invention. Hereinafter, the content extraction method according to the first embodiment of the present invention will be explained with reference to FIG. 13.

When extracting music for transfer, first the transfer candidate extractor 128 acquires the content of the content database 138 via the content management portion 132 (step S172). When the content of the content database 138 are acquired, next, the transfer candidate extractor 128 acquires the content of the mobile device database 140 via the mobile device database management portion 134 (step S174). Note that the order of acquiring the content may be reversed.

When the transfer candidate extractor 128 acquires the content of the content database 138 and the mobile device database 140 in the above-described step S172 and step S174, the transfer candidate extractor 128 searches, from among the acquired content, for music and playlists that exist on the content database 138 and that do not exist on the mobile device database 140, and acquires a record set (step S176). When the transfer candidate extractor 128 acquires the record set, it sorts the record set according to a sort order specified from a higher level, such as the automatic transfer control portion 124 (step S178). In other words, normally the record set is sorted with a first sort key being the album name and a second sort key being the CD track number. When there is insufficient free space on the mobile terminal 200, and when transferring as much of the music as possible to the mobile terminal 200, the record set is sorted with the first sort key being the date and time of recording.

When the record set is sorted, in order to return it to the automatic transfer control portion 124 separated into music and playlists, the record set data is stored in array variables. In the first embodiment, the record set data is stored sorted into two types of array variable, namely aContent[ ] and aPlaylist[ ]. aContent[ ] is an array variable in which the music record is stored, and aPlaylist[ ] is an array variable in which the playlist record is stored. First, the array variable contents are initialized (step S180) by storing nothing (Empty) in the aContent[ ] and the aPlaylist[ ] array variables. When the contents have been initialized, the process moves to the first record of the record set sorted in the above-described step S176 (step S182).

Next, it is determined whether or not the current record is the final record (step S184). When it is not the final record, it is determined whether or not the current record type is music or playlist (step S186). When the current record type is music, the content of the record is added to the aContent[ ] array variable (step S188), and the process moves to the next record (step S192). On the other hand, if the current record type is playlist, the content of the record is added to the aPlaylist[ ] array variable (step S190) and the process then moves to the next record (step S192).

When adding the content of the record to the array variables in this way, the adding of the record content to the array variables is repeated until it is determined in the above-described step S 184 that the current record is the final record. Then, when it is determined in the above-described step S184 that the current record is the final record, the content of the aContent[ ] array variable and of the aPlaylist[ ] array variable is called and returned to the source (in the first embodiment, to the automatic transfer control portion 124) (step S194) and the process is ended.

The content transfer method according to the first embodiment of the present invention is explained above with reference to FIG. 13. Next, the scheduling process to schedule the transfer order of the extracted content by the transfer scheduler 130 will be explained.

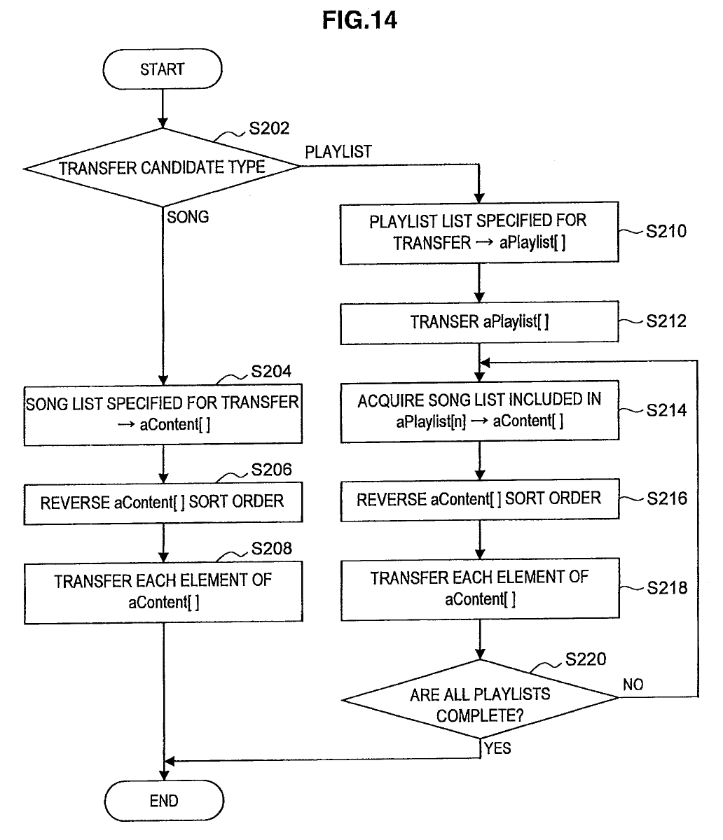

FIG. 14 is a flow chart illustrating the scheduling process to schedule the transfer order of the extracted content in the content transfer method according to the first embodiment of the present invention. Hereinafter, the scheduling process according to the first embodiment of the present invention will be explained in detail with reference to FIG. 14.

First, the type of the transfer candidate transmitted by the transfer scheduler 130 from the higher layer automatic transfer control portion 124 is checked (step S202). If the transfer candidate is music, the transfer scheduler 130 receives the content of the aContent[ ] array variable transmitted from the automatic transfer control portion 124 (step S204). The aContent[ ] array variable content is a list of the music specified for transfer to the mobile terminal 200.

When the transfer scheduler 130 receives the content of the aContent[ ] array variable, the sort order of the record stored in the aContent[ ] array variable is reversed (step S206). Then, each of the elements stored in the aContent[ ] array variable is transferred, in the reversed order (step S208). In the first embodiment, the transfer scheduler 130 instructs the mobile device transfer management portion 136 to transfer each of the elements stored in the aContent[ ] array variable, in the reversed order.

On the other hand, if, as a result of the determination made in the above-described step S202, the transfer candidate is a playlist, the transfer scheduler 130 receives the content of the aPlaylist[ ] array variable transmitted from the automatic transfer control portion 124 (step S210). The content of the aPlaylist[ ] array variable is a list of the playlists specified for transfer to the mobile terminal 200.

When the playlist is transferred to the mobile terminal 200, not only the playlist but also the music belonging to the playlist is transferred. First, each of the elements stored in the aPlaylist[ ] array variable is transferred to the mobile terminal 200 (step S212). Then, the music included in an aPlaylist[n] array variable, in which is stored a number n (n is a positive integer) of transfer candidate playlists, is acquired from the content database 138. The acquired music list is stored in the aContent[ ] array variable (step S214). Further, the sort order when storing the content in the aContent[ ] array variable is the same order as the order of the music on the playlist.

When the music list is stored in the aContent[ ] array variable, the sort order of the record stored in the aContent[ ] array variable is reversed (step S216). Then, each of the elements stored in the aContent[ ] array variable is transferred, in the reversed order (step S218). In the first embodiment, the transfer scheduler 130 instructs the mobile device transfer management portion 136 to transfer each of the elements stored in the aContent[ ] array variable, in the reversed order.

When the transfer of each of the elements of the aContent[ ] array variable is complete, it is determined whether or not the transfer of the music for all the playlists is complete (step S220). If the transfer of the music for all the playlists is complete, the process ends as it is. On the other hand, if the transfer of the music for all the playlists is not complete, the process is continually repeated for each of the remaining elements stored in the aPlaylist[ ] array variable that have not yet been transferred to the mobile terminal 200.

Note that in the above-described step S208 and step S218, the music that is already stored in the mobile terminal 200 is not transferred to the mobile terminal 200.

The scheduling process according to the first embodiment of the present invention is described above. This type of transfer process from the information processing device 100 to the mobile terminal 200 will be explained in further detail with reference to the figures.

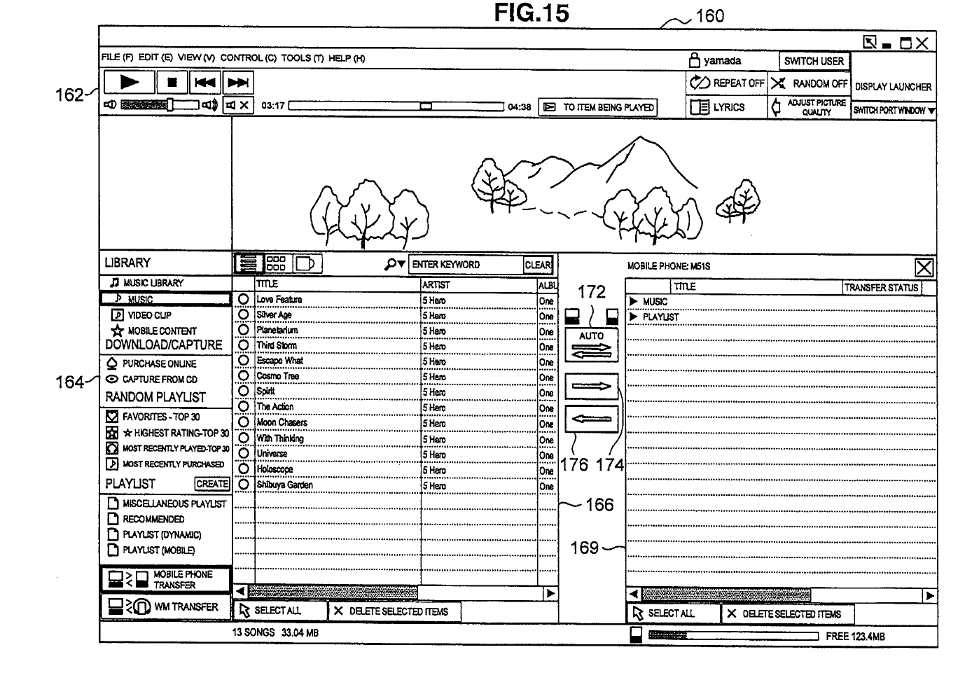

FIG. 15 to FIG. 17 are explanatory diagrams showing examples of screens displayed on the display portion 112 of the information processing device 100 according to the first embodiment of the present invention.

First, FIG. 15 will be explained. FIG. 15 shows an example of the screen displayed on the display portion 112 when the information processing device 100 is connected to the mobile terminal 200 and the juke box program 160 is activated on the information processing device 100. Note that, in order to keep the explanation simple, only information for the music belonging to one album in the information processing device 100 is displayed on the juke box program 160 here. Also, it is assumed that no content is stored in the mobile terminal 200.

In contrast to FIG. 7 to FIG. 9, content transfer buttons 172, 174 and 176 are displayed in FIG. 15, which are used to transfer the content between the information processing device 100 and the mobile terminal 200. Further, a terminal content display portion 169 is displayed, which is used to display the information for the content stored in the mobile terminal 200. The content transfer button 172 is a button for the automatic transfer of the content between the information processing device 100 and the mobile terminal 200, the content transfer button 174 is a button to transfer the content specified by the user from the information processing device 100 to the mobile terminal 200, and the content transfer button 176 is a button to transfer the content specified by the user from the mobile terminal 200 to the information processing device 100.

Here, when the content transfer button 172 is depressed by clicking a mouse or the like, the content targeted for transfer is automatically extracted, and the extracted content is transferred from the information processing device 100 to the mobile terminal 200.

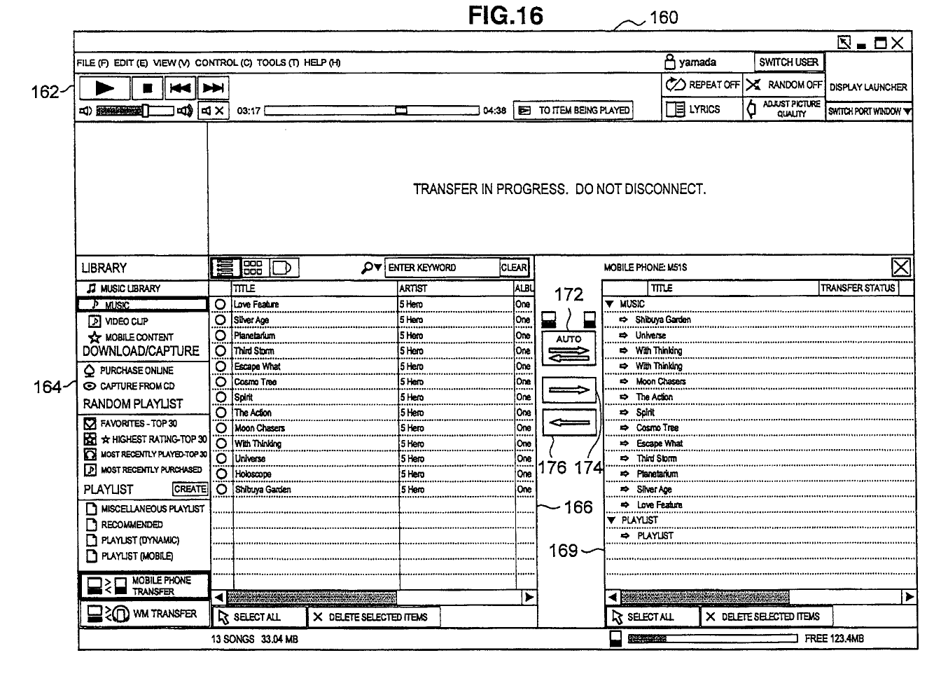

FIG. 16 shows an example of the screen displayed when the content transfer button 172 shown in FIG. 15 is depressed by clicking a mouse or the like. As explained above, when the content is being transferred from the information processing device 100 to the mobile terminal 200, the sort order of the content is reversed. Therefore, as shown in FIG. 16, the content displayed on the terminal content display portion 169 is in exact reverse to the order on the information processing device 100. By re-sorting in this way for the display on the juke box program 160, the transfer order of the music files can be ascertained. Also, by displaying on the terminal content display portion 169 icons that indicate the transmission status of the music files (in FIG. 16, a right-pointing arrow icon attached to each piece of the music and each of the playlists), it is possible to ascertain the transmission progress status of the music files.

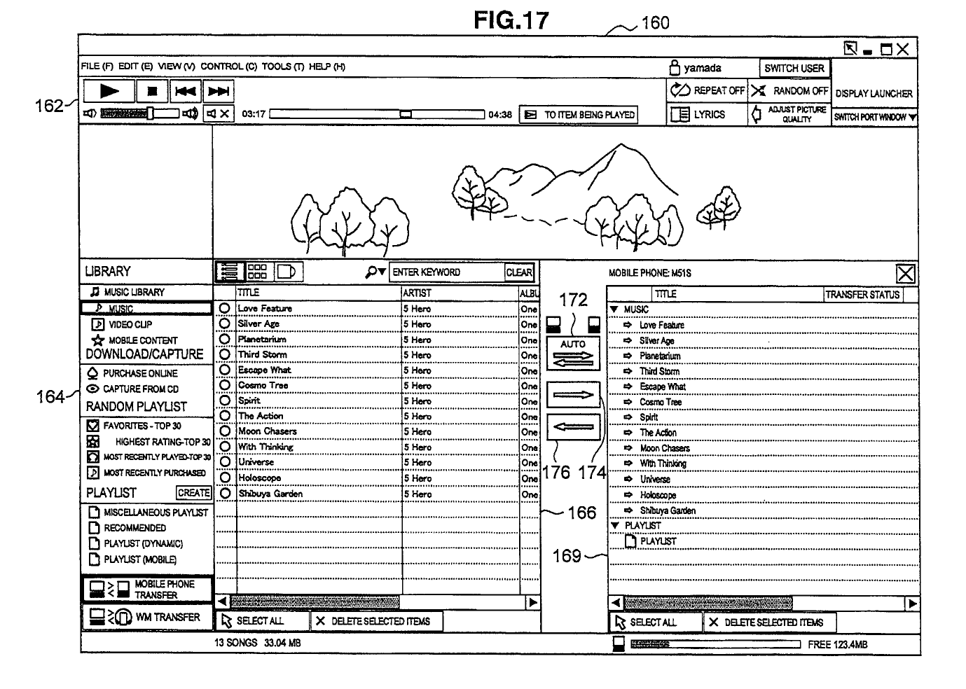

FIG. 17 shows an example of the screen displayed when the transfer of the music from the information processing device 100 to the mobile terminal 200 is complete. As shown in FIG. 17, after the transfer is complete, by displaying the content information on the terminal content display portion 169 so that the order on the information processing device 100 and the order of transfer to the mobile terminal 200 match each other, it is possible to show the user that the music has been correctly transferred from the information processing device 100 to the mobile terminal 200.

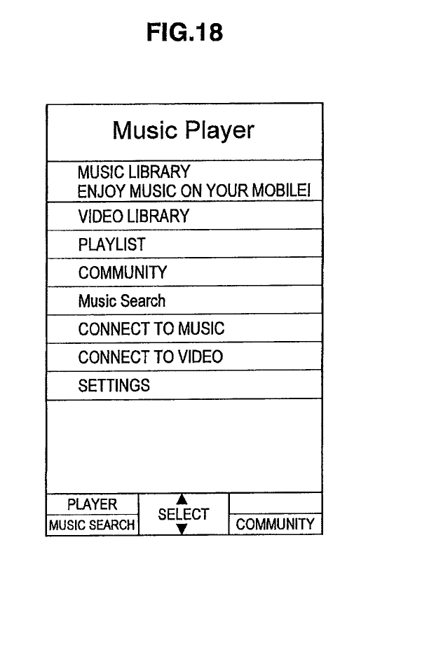

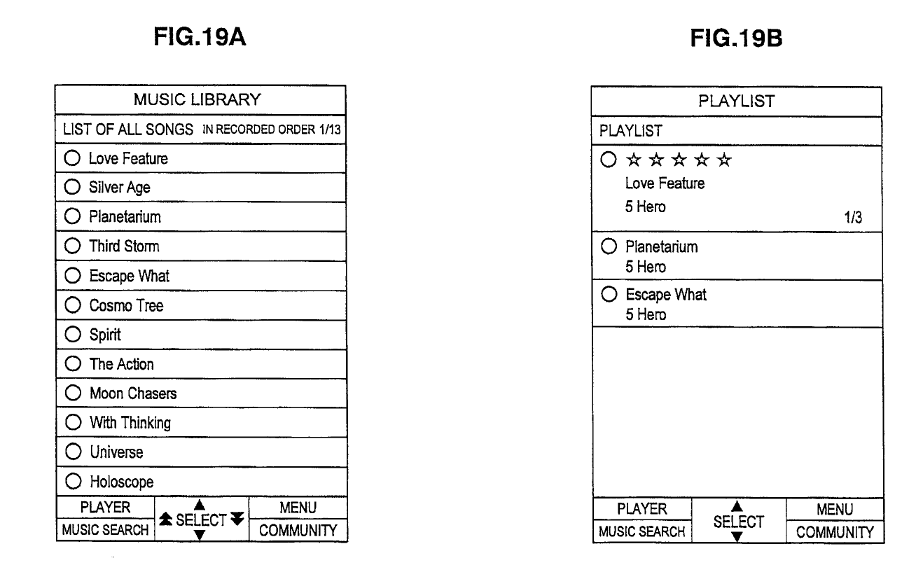

Next are examples of screens displayed on the mobile terminal 200. FIG. 18, FIG. 19A and FIG. 19B are explanatory diagrams illustrating examples of the screens displayed on the display portion 212 of the mobile terminal 200 according to the first embodiment of the present invention. FIG. 18 shows an example of a menu screen displayed when music playback software is executed on the mobile terminal 200. FIG. 19A shows an example of the screen displayed when “Music Library” (shown in FIG. 18) is selected. FIG. 19B shows an example of the screen displayed when “Playlist” (shown in FIG. 18) is selected. As shown in FIG. 19A and FIG. 19B, it can be seen that the music is displayed in order of the album and the playlist on the mobile terminal 200.

The music transfer process from the information processing device 100 to the mobile terminal 200 is explained above. As explained above, in the first embodiment, when automatically transferring the content from the information processing device 100 to the mobile terminal 200, the sort order of the content is reversed on the information processing device 100 and then transferred, so that the music is displayed in order of the album and the playlist on the mobile terminal 200. By reversing the content sort order and then transferring the content, when the content is displayed as a list on the mobile terminal 200, the content can be displayed grouped by each of the albums.

Moreover, in the first embodiment, the content is first transferred in units of album, and next the playlists and the content to which the playlists refer are transferred, thus preventing scattering of the music within the album on the mobile terminal 200. Also, each piece of the music within the album is transferred in descending order of the CD track number, and the content is thus displayed on the mobile terminal 200 in ascending order of the CD track number.

Next, modified examples of the first embodiment will be explained.

### FIRST MODIFIED EXAMPLE

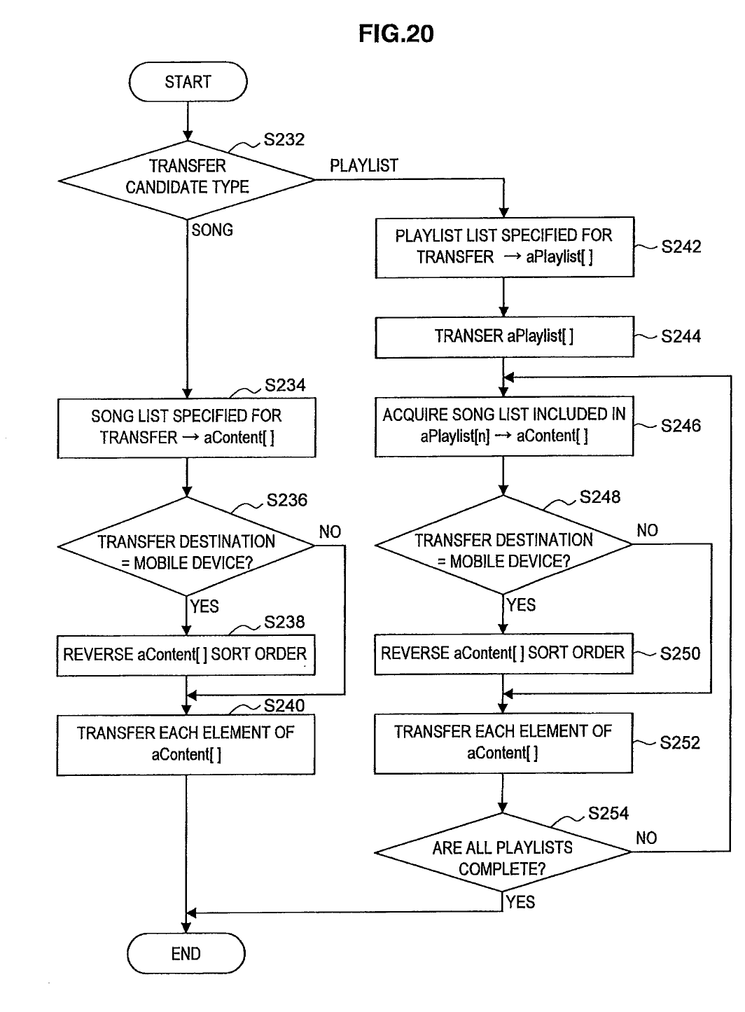

FIG. 20 is a flow chart illustrating a modified example of the scheduling process to schedule the extracted content transfer order in the content transfer method according to the first embodiment of the present invention. The point of difference with FIG. 14 is the addition of a new step in which it is determined whether or not the transfer destination is the mobile terminal 200.

First, in the same way as FIG. 14, the type of the transfer candidate transmitted by the transfer scheduler 130 from the higher layer automatic transfer control portion 124 is checked (step S232). If the transfer candidate is music, the transfer scheduler 130 receives the content of the aContent[ ] array variable transmitted from the automatic transfer control portion 124 (step S234).

When the transfer scheduler 130 receives the content of the aContent[ ] array variable, it is determined whether or not the device connected to the information processing device 100 is the mobile terminal 200 (step S236). If the device connected to the information processing device 100 is the mobile terminal 200, the sort order of the record stored in the aContent[ ] array variable is reversed (step S238). Then, each of the elements stored in the aContent[ ] array variable is transferred, in the reversed order (step S240). On the other hand, if the device connected to the information processing device 100 is not the mobile terminal 200, and is, for example, a mobile music playback device, each of the elements stored in the aContent[ ] array variable is transferred in the original order (step S240).

Meanwhile, if, as a result of the determination made in the above-described step S232, the transfer candidate is a playlist, the transfer scheduler 130 receives the content of the aPlaylist[ ] array variable transmitted from the automatic transfer control portion 124 (step S242). Then, each of the elements stored in the aPlaylist[ ] array variable is transferred to the mobile terminal 200 (step S244). Then, the music included in the aPlaylist[n] array variable, in which is stored a number n (n is a positive integer) of transfer candidate playlists, is acquired from the content database 138. The acquired music list is stored in the aContent[ ] array variable (step S246). Further, the sort order when storing the content in the aContent[ ] array variable is the same order as the order of the music on the playlist.

When the music list is stored in the aContent[ ] array variable, it is determined whether or not the device connected to the information processing device 100 is the mobile terminal 200 (step S248). If the device connected to the information processing device 100 is the mobile terminal 200, the sort order of the record stored in the aContent[ ] array variable is reversed (step S250). Then, each of the elements stored in the aContent[ ] array variable is transferred, in the reversed order (step S252). On the other hand, if the device connected to the information processing device 100 is not the mobile terminal 200, and is, for example, a mobile music playback device, each of the elements stored in the aContent[ ] array variable is transferred in the original order (step S252).

When the transfer of each of the elements of the aContent[ ] array variable is complete, it is determined whether or not the transfer of the music for all the playlists is complete (step S254). If the transfer of the music for all the playlists is complete, the process ends as it is. On the other hand, if the transfer of the music for all the playlists is not complete, the process is continually repeated for each of the elements stored in the aPlaylist[ ] array variable until the music transfer is complete for all of the playlists.

In this way, by reversing or not reversing the record sort order depending on the type of the transfer destination device connected to the information processing device 100, the record sort order can be reversed before transferring for types of device for which it is necessary to reverse the record sort order before transferring, and, in the case of devices for which it is not necessary to reverse the record sort order before transferring, the record can be transferred in its original order.

### SECOND MODIFIED EXAMPLE

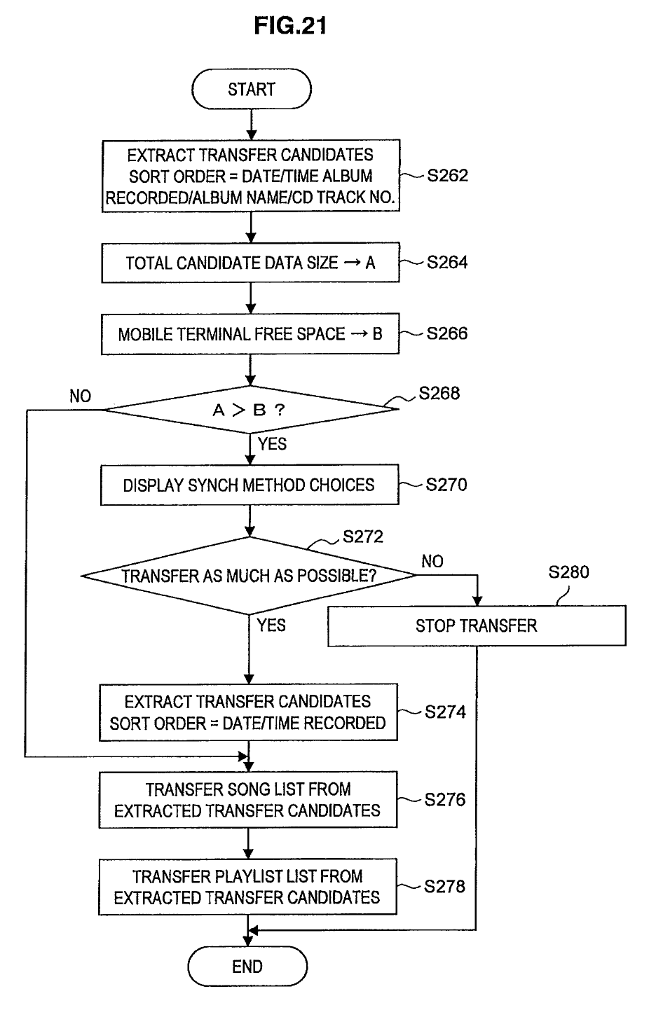

FIG. 21 is a flow chart illustrating a modified example of the content transfer method according to the first embodiment of the present invention. The point of difference with FIG. 11 is that when the transfer candidates are extracted, the sort order used is first the date and time of recording the album, then the name of the album and the CD track number.

When the music for transfer from the information processing device 100 to the mobile terminal 200 is automatically extracted, and the music is transferred from the information processing device 100 to the mobile terminal 200, first the music transfer candidates are extracted by the automatic transfer control portion 124. However, where in FIG. 11 the transfer candidates are sorted in ascending order of the album name and the CD track number when they are extracted, in FIG. 21, the transfer candidates are sorted in ascending order of the date and time of recording the album, the album name and the CD track number (step S262). Here, the information about the date and time of recording the album may be acquired, for example, from the date and time on the “mbjContent” table on the content database 138. In other words, for the albums that are transfer candidates, the date and time of recording of the album may be the date and time the music is first recorded, and they may be sorted using that date and time. From this point onwards, the same processes are performed as in FIG. 11, so the flow will be explained in brief. When the transfer candidates are extracted, the total data size of the music extracted by the automatic transfer control portion 124 is calculated (step S264), and the free space on the mobile terminal 200 is calculated (step S266). When both the calculations are complete, the two calculations are compared (step S268), and if the free space on the mobile terminal 200 is the smaller value, the automatic transfer control portion 124 notifies the user interface 120 to display sync method choices (step S270). Next, the user interface 120 determines whether or not the user has selected to transfer as much of the music as possible (step S272). If the user has selected to transfer as much of the music as possible, the automatic transfer control portion 124 once more extracts the candidate music for transfer (step S274). When it is determined in the above-described step S268 that the total data size of the music is larger or when the extraction of the candidate music for transfer is complete in the above-described step S274, first the song list is transferred from among the extracted transfer candidates (step S276). Next, the playlist list is transferred from among the extracted transfer candidates (step S278). Note that in the above-described step S272, if the user has not selected to transfer as much of the music as possible, the automatic transfer process to the mobile terminal 200 is stopped (step S280).

Note that each of the above-described methods may be performed by the CPU 102 sequentially reading and executing computer programs that are stored internally in the information processing device 100 (for example, in the HDD 116) and that are programmed to operate a configuration as that shown in FIG. 3. A computer-readable recording medium may also be provided on which the computer program is stored. This type of recording medium may be, for example, a magnetic disk or an optical disk.

It should be understood by those skilled in the art that various modifications, combinations, sub-combinations and alterations may occur depending on design requirements and other factors insofar as they are within the scope of the appended claims or the equivalents thereof.

For example, in the above-described embodiment, it is not necessary to perform each of the steps on the information processing device 100 following a chronological timeline according to the order shown in the figures. For example, each of the steps of the information processing device 100 may include processing that is performed in parallel or separately (for example, parallel processing or object processing).

What is claimed is:

1. An information processing device that performs content transfer with a content storage device on which is stored content that has content identification information, the information processing device comprising:
a storage portion that stores content that has content identification information and stores at least one of a first attribute and a second attribute that correspond to the content identification information for each of the content;
a content extractor that extracts, from among the content stored in the storage portion, the content for transfer to the content storage device; and
a transmission portion that transmits the content extracted by the content extractor to the content storage device in an order that is based on the first attribute and the second attribute, with priority given to the first attribute.

2. The information processing device according to claim 1, wherein
the transmission portion, when transmitting the content to the content storage device based on the first attribute, transmits the content in descending order of the order based on the first attribute.

3. The information processing device according to claim 1, further comprising:
a display portion that displays information for the content stored in the storage portion; and
a control portion that controls the display of the content information on the display portion.

4. The information processing device according to claim 3, wherein
the control portion displays the information for the content to be transferred to the content storage device on the display portion in descending order of the order based on the first attribute.

5. The information processing device according to claim 3, wherein
the control portion, when transmitting the content to the content storage device, displays icons on the display portion that indicate the progress status for each of the content displayed on the display portion.

6. The information processing device according to claim 1, wherein
the transmission portion, depending on the type of the content storage device transferring the content, changes whether to perform transmission in descending order of the order based on the first attribute.

7. The information processing device according to claim 1, wherein
the transmission portion, when there is insufficient free space on the content storage device transferring the content, transmits the content in an order of priority starting from the content with the most recent date and time of recording on the information processing device.

8. The information processing device according to claim 3, wherein
the control portion, when there is insufficient free space on the content storage device transferring the content, allows the user to select whether to transfer as much of the content as possible until the space on the content storage device becomes full.

9. The information processing device according to claim 1, wherein
the content extractor performs extraction in order of the name of the first attribute.

10. The information processing device according to claim 1, wherein
the content extractor performs extraction according to the first attribute when the first attribute is the date and time of recording of the content belonging to the first attribute on the information processing device.

11. An information processing method for performing content transfer with a content storage device on which is stored content that has content identification information, the information processing method comprising the steps of:
storing content that has content identification information and storing at least one of a first attribute and a second attribute that correspond to the content identification information for each of the content;
extracting, from among the content stored in the storing step, content for transfer to the content storage device; and
transferring the content extracted in the content extracting step to the content storage device in an order based on the first attribute and the second attribute, with priority given to the first attribute.

12. A computer program that performs content transfer with a content storage device on which is stored content that has content identification information, the computer program comprising instructions that command a computer to perform the steps of:
storing content that has content identification information and storing at least one of a first attribute and a second attribute corresponding to the content identification information for each of the content;
extracting, from among the content stored in the storing step, content for transfer to the content storage device; and
transferring the content extracted in the content extracting step to the content storage device in an order based on the first attribute and the second attribute, with priority given to the first attribute.
